(19) United States
(12) Patent Application Publication
(10) Pub. No.: US 2025/0384001 A1
(43) Pub. Date: Dec. 18, 2025

(54) Shared Memory Controller with Direct Memory Access Architecture for On-Chip Memory

(71) Applicant: Marvell Asia Pte Ltd, Singapore (SG)

(72) Inventors: Anh Nguyen, Ho Chi Minh City (VN); Linh Nguyen, Ho Chi Minh City (VN); Tran Tan Duc, Ho Chi Minh City (VN)

(73) Assignee: Marvell Asia Pte Ltd, Singapore (SG)

(21) Appl. No.: 19/238,209

(22) Filed: Jun. 13, 2025

Related U.S. Application Data
(60) Provisional application No. 63/660,453, filed on Jun. 14, 2024.

(51) Int. Cl. G06F 13/28

(52) U.S. Cl. CPC G06F 13/28; G06F 2213/28

(57) ABSTRACT

The present disclosure describes System on Chip (SoC) architecture that facilitates disaggregation of memory-to-memory operations. The SoC architecture includes a host interface that communicates with a host system, processor cores, and an Advanced extensible Interface (AXI) interconnect coupling the host interface with processor cores. The SoC architecture includes an on-chip memory (OCM) subsystem coupled to the AXI interconnect, where the OCM subsystem contains memory banks, a Direct Memory Access (DMA) interconnect coupled directly with respective memories of processor cores, and a shared memory controller coupled with the AXI interconnect, memory banks, and DMA interconnect. The shared memory controller includes an OCM-internal path connecting the shared memory controller directly to memory banks within the OCM subsystem and a DMA engine that executes memory-to-memory operations by transferring data directly between memory banks through the OCM-internal path or respective memories of processor cores via a DMA interconnect.

### CROSS-REFERENCE TO RELATED APPLICATION

This present disclosure claims priority to U.S. Provisional Patent Application Ser. No. 63/660,453 filed Jun. 14, 2024, the disclosure of which is incorporated by reference herein in its entirety.

### BACKGROUND

System-on-Chip (SoC) architectures integrate processing cores, memory subsystems, and peripheral controllers onto single semiconductor substrates through Advanced extensible Interface (AXI) interconnects that implement standardized protocols for data transactions. On-Chip Memory (OCM) subsystems contain Static Random-Access Memory (SRAM) arrays positioned on the silicon die, which provide data storage that processing elements access through communication pathways that carry address information, payload data, and response acknowledgments across distinct signal channels that operate concurrently within the SoC architecture.

OCM subsystems integrate SRAM banks that connect to AXI interconnects through memory controllers, which translate between SRAM interface signals and AXI protocol transactions using bridge circuits. These circuits enable processing cores and peripheral devices to access on-chip storage resources. SRAM arrays maintain data without refresh operations, delivering access times measured in nanoseconds compared to external memory technologies that require hundreds of nanoseconds per transaction, establishing performance differentials that influence SoC operational characteristics.

Memory controllers function as interface circuits between AXI interconnects and SRAM arrays, implementing address translation logic that converts processor-generated addresses into physical memory locations within OCM subsystems through mapping algorithms that coordinate logical address spaces with physical storage boundaries. These memory controllers attach to AXI interconnects as target devices that receive transaction requests from processing cores, Direct Memory Access (DMA) controllers, and peripheral components through protocol-defined communication sequences.

DMA controllers operate as independent data transfer engines that generate AXI transaction requests to reach memory controllers managing OCM subsystems, enabling bulk data movement between SRAM banks without Central Processing Unit (CPU) intervention. DMA controllers implement command processing logic that interprets transfer parameters, source addresses, destination addresses, and computational operations such as Exclusive OR calculations performed during data movement between SRAM locations within the SoC architecture.

AXI interconnect traffic often creates performance bottlenecks when multiple system components simultaneously request access to OCM subsystems through shared communication pathways, where arbitration mechanisms resolve competing requests through priority-based selection algorithms. Arbitration delays across the AXI interconnect can accumulate as processing cores, DMA controllers, and peripheral devices compete for memory controller access. This can extend transaction completion times beyond baseline SRAM access latencies and reduce overall memory transfer efficiency within SoC architectures through protocol overhead that compounds during high-traffic operational scenarios.

### SUMMARY

This summary is provided to introduce subject matter that is further described in the Detailed Description and Drawings. Accordingly, this Summary should not be considered to describe essential features nor used to limit the scope of the claimed subject matter.

In various aspects, an apparatus includes a system on a chip (SoC) that facilitates disaggregation of memory-to-memory operations, where the SoC comprises a host interface that is configured to communicate with a host system, one or more processor cores, and an Advanced extensible Interface (AXI) interconnect that is coupled between the host interface and the one or more processor cores. The SoC contains an on-chip memory (OCM) subsystem that is coupled to the AXI interconnect, where the OCM subsystem comprises memory banks, a Direct Memory Access (DMA) interconnect that is coupled directly with respective memories of the one or more processor cores, and a shared memory controller (SMC) that is coupled with the AXI interconnect, the memory banks, and the DMA interconnect. The shared memory controller comprises an OCM-internal path that connects the shared memory controller directly to the memory banks within the OCM subsystem and a DMA engine that is configured to execute memory-to-memory operations by transferring data directly between the memory banks through the OCM-internal path or the respective memories of the one or more processor cores via the DMA interconnect.

In other aspects, a method facilitates management of memory-to-memory operations in a SoC, which includes a host interface, one or more processor cores, an AXI interconnect that is coupled between the host interface and the one or more processor cores, and an on OCM subsystem, where the OCM subsystem comprises memory banks and a SMC with a DMA engine, where the method comprises receiving, at the SMC, a request for a memory-to-memory operation, determining that the memory-to-memory operation is between the memory banks of the OCM subsystem, directing the memory-to-memory operation through an OCM-internal path that connects the shared memory controller directly to the memory banks, where the SMC accesses the memory banks directly without traversing the AXI interconnect, and executing the memory-to-memory operation by transferring data directly between the memory banks through the OCM-internal path.

In various aspects, a method facilitates performance of MBIST of a SoC, which includes one or more processor cores, respective memories of the one or more processor cores, MBIST circuitry, and dual-mode signal paths that connect functional logic to the respective memories of the one or more processor cores, where the method comprises generating memory test patterns, transmitting the test patterns to the respective memories of the one or more processor cores through the dual-mode signal paths that are also used for functional data transfers, receiving memory test response data from the respective memories of the one or more processor cores through the dual-mode signal paths, analyzing the test response data to detect memory failures, and maintaining direct signal connections between the functional logic and the respective memories of the one or more processor cores during transitions between normal operation mode and test mode.

The details of one or more implementations are set forth in the accompanying drawings and the following description. Other features and advantages will be apparent from the description and drawings, and from the claims.

### BRIEF DESCRIPTION OF THE DRAWINGS

The details of one or more implementations of a System-on-a-Chip (SoC) that includes a shared memory controller (SMC) with direct memory access (DMA) architecture for on-chip memory (OCM) are set forth in the accompanying figures and the detailed description below. In the figures, the left-most digit of a reference number identifies the figure in which the reference number first appears. The use of the same reference numbers in different instances in the description and the figures indicates like elements:

FIG. 1 illustrates an example SoC architecture that is suitable to implement a combined shared memory controller-direct memory access (SMC-DMA) aspects described herein;

FIG. 2 illustrates an example MBIST shared-bus insertion architecture that can be implemented in a suitable SoC architecture;

FIG. 3 illustrates an example operating environment in which the DMA interconnect can be implemented;

FIG. 4 illustrates an example consolidated memory controller architecture in accordance with one or more aspects;

FIG. 5 depicts an example method for implementing combined SMC-DMA aspects, which addresses inefficient memory-to-memory operations by combining DMA functionality as part of an SMC;

FIG. 6 depicts an example method for implementing memory testing with a shared bus in accordance with one or more aspects; and

FIG. 7 illustrates an example System-on-Chip (SoC) that has an architecture that implements the aspects described herein.

### DETAILED DESCRIPTION

Described herein is a System-on-a-Chip (SoC) that includes a shared memory controller (SMC) with direct memory access (DMA) architecture on-chip memory (OCM) subsystems, which can enable disaggregation of memory operations of the SoC. This may address inefficient memory-to-memory operations by combining DMA functionality with the SMC. The SMC-DMA combination optimizes data paths based on types of memory-to-memory operations. For example, memory-to-memory operations within shared memory banks of an OCM subsystem are directed via an internal path within the OCM subsystem. The internal path connects the SMC-DMA combination directly to the memory banks within the OCM subsystem, bypassing an Advanced extensible Interface (AXI) interconnect and thereby eliminating the latency and arbitration delays that occur when data movements utilize the AXI interconnect.

In various aspects, a DMA interconnect bypasses the AXI interconnect for memory-to-memory operations that occur between the memory banks of the OCM subsystem and distributed processor core memories. The DMA interconnect utilizes light-weight DMA engines within selected hops to execute direct memory-to-memory transfers between respective memories, thereby reducing data movement latency by avoiding use of centralized DMA engine routing requirements.

A Memory Built-In Self-Test (MBIST) controller coupled with the DMA interconnect can achieve dual-path utilization through the DMA interconnect that enables memory testing operations to execute via pathways that also carry functional memory-to-memory operations. MBIST controller transmits memory test patterns through dual-mode signal paths that maintain functional data transfer capability during normal operation and test stimuli transmission during test mode. A shared-bus insertion test interface captures read data from respective memories through input registers that latch test stimuli, output registers that capture the read data, and a multiplexer that selects the read data from the respective memories.

A DMA engine of the SMC-DMA combination executes computational functions that include Exclusive OR (XOR) operations, Cyclic Redundancy Check (CRC) calculations, hashing operations, and pattern matching operations on data internal to the OCM subsystem. The DMA engine performs memory scrubbing and memory initialization through DMA commands that operate within the OCM subsystem.

### Operating Environment

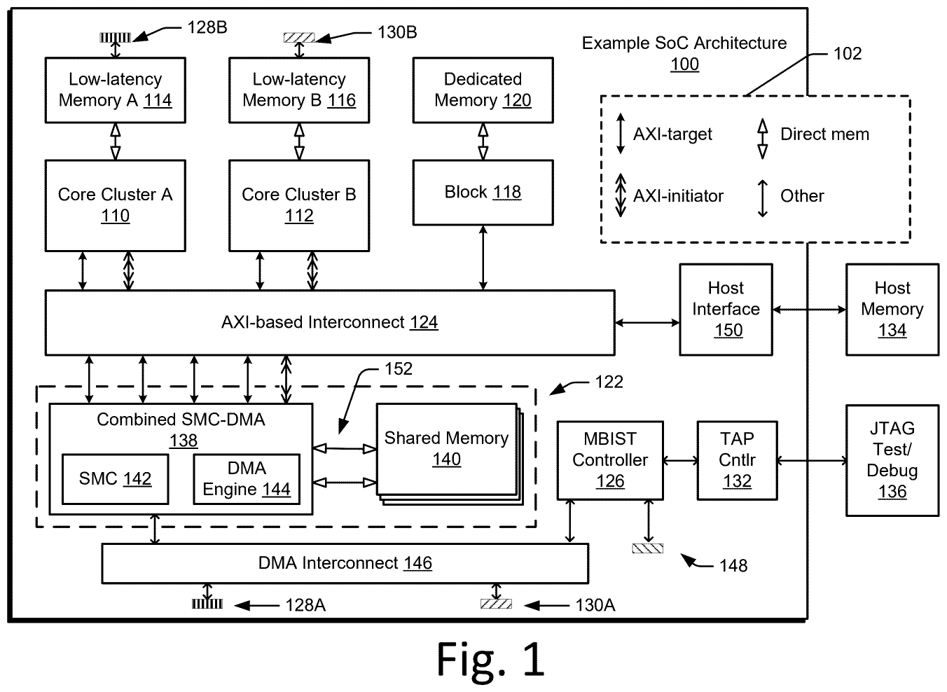

FIG. 1 illustrates an example System on a chip (SoC) architecture 100 that may be suitable to implement a SMC with DMA architecture for disaggregating memory operations of OCM subsystems. In aspects, the SoC architecture 100 or operating environment may be implemented as part of a computing device, such as a laptop computer, desktop computer, or server, any of which may be configured as part of a storage network or cloud storage. Generally, the SoC architecture 100 integrates multiple computing subsystems onto a single integrated circuit, which can combine a variety of functional components of a computing system to collectively perform diverse computing functions across various applications, ranging from mobile devices to automotive systems.

As depicted, the SoC architecture 100 may include core clusters (e.g., core cluster A 110 and core cluster B 112), low-latency memory (e.g., low-latency memory A 114 and low-latency memory B 116), block 118, a dedicated memory 120, an OCM subsystem 122, AXI-based interconnect 124 (AXI interconnect 124), MBIST controller 126, direct-connect-indicating bars 128A, 128B, 130A, and 130B, Test Access Port (TAP) controller 132. As depicted, host memory 134 and Joint Test Action Group (JTAG) Test/Debug 136 interface may be external to the SoC architecture 100 and connected to one or more of the components thereof. In aspects, the OCM subsystem 122 may include a combined Shared Memory Controller-Direct Memory Access (SMC-DMA) unit 138, a shared memory 140, an SMC 142, a DMA engine 144, and a DMA interconnect 146.

FIG. 1 includes an interface legend 102, which distinguishes between the various types of inter-component interfaces in the SoC architecture 100. As shown in the legend 102, the interfaces may include AXI-target interfaces that are represented by indented full arrows, AXI-initiator interfaces that are represented by open double arrows, memory dedicated interfaces that are represented by closed American Society of Mechanical Engineers (ASME) arrows, and other types of interfaces that are represented by open 90-degree arrows.

AXI-target interfaces serve as reception points for transactions within the SoC architecture 100, managing incoming requests from other components. Components with AXI-target interfaces include the AXI-based interconnect 124, combined SMC-DMA unit 138, core clusters A and B (110 and 112), block 118, and host interface 150. These interfaces support standard protocols for accepting and acknowledging commands and data, ensuring interoperability between system components.

In various implementations, AXI-initiator interfaces may originate transactions directed toward other components in the SoC architecture 100, which positions them as sources of data transfer operations. Examples of components that may utilize AXI-initiator interfaces include the interface of the AXI-based interconnect 124 with the core clusters A and B (110, 112). Generally, the AXI-initiator interfaces adhere to protocol specifications that define addressing mechanisms and handshaking procedures, which may create predictable communication pathways across the system.

Memory-dedicated interfaces connect processing elements directly to memory resources, reducing access latency by bypassing standard bus protocols. Examples include connections between core clusters A and B (110, 112) and their respective low-latency memories A and B (114, 116), between block 118 and dedicated memory 120, and between the SMC-DMA unit 138 and shared memory 140. These interfaces implement memory-specific signaling that accommodates SRAM timing requirements, eliminating protocol translations and creating contention-free paths for time-critical operations.

In some cases, other interface types may create specialized connections between specific SoC architecture 100 components, which address requirements that standard protocols cannot efficiently fulfill. Examples of components that may utilize these specialized interfaces include the MBIST controller 126, which connects to various memory elements for testing operations; the TAP controller 132, which interfaces with the JTAG Test/Debug 136 interface for external access to testing capabilities; and the processing elements within core clusters, which may use specialized links for internal coordination. Generally, these specialized interfaces serve defined functions between specific endpoints, which differs from the general-purpose nature of bus-based communications that accommodate multiple devices and transaction types.

Returning to the discussion of the components of the SoC architecture 100, the core clusters A and B (110, 112) may perform computational operations. In aspects, core clusters A and B (110, 112) contain multiple processor cores that execute instruction sets and process data, which may share certain resources such as cache memory and power management units. Generally, core clusters connect directly to their respective low-latency memories A and B (114, 116) through private memory dedicated interfaces, which may minimize access latency for time-sensitive operations.

In various implementations, core clusters A and B (110, 112) connect to the AXI-based interconnect 124 through AXI-initiator interfaces, which may allow them to communicate with other SoC components and peripheral devices. Each cluster can operate independently for task execution, which supports parallel processing capabilities, while synchronization may occur through shared memory resources. In some cases, the SoC architecture 100 may include additional core clusters beyond the two depicted, which provides scalability to meet various computational requirements.

While not shown, the SoC architecture 100 may include other components processing units, such as Graphics Processing Units (GPUS), Digital Signal Processors (DSPs), Neural Processing Units (NPUs), Physics Processing Units (PPUs), Vector Processing Units (VPUs), Image Signal Processors (ISPs), and the like.

The memory subsystems of SoC architecture 100 include OCM subsystems and external memory. OCM subsystems include low-latency memory A and B (114, 116), dedicated memory 120, and shared memory 140. These memory elements reside on the same silicon die as computational components, enabling reduced signal propagation distance and decreased access latency. OCM utilizes SRAM technology, requiring no refresh cycles, providing faster access times and lower power consumption than external memory.

In aspects, low-latency memory A and B (114, 116) may be connected to and utilized by core clusters A and B (110, 112), respectively, through memory-dedicated interfaces. Generally, the low-latency memory A and B (114, 116) provide fast data access for time-critical operations by positioning SRAM arrays physically close to processing cores (e.g., core clusters A and B (110, 112)) and implementing direct access paths that bypass shared interconnects. The low-latency memory type may typically be chosen for performance-sensitive functions where processing delays would create bottlenecks, which makes it suitable for core-local storage, instruction caches, and real-time computing applications. In various implementations, SRAM arrays function as high-speed memory components that store instructions and data with rapid, uniform access times, which support performance-critical operations within SoC architectures by providing temporary storage that requires no refresh cycles.

In aspects, low-latency memory A and B (114, 116) may maintain a one-to-one relationship with their corresponding clusters through memory dedicated interfaces, which creates private paths that avoid contention. Generally, the low-latency memory A and B (114, 116) interface with the MBIST controller 126 through other specialized interfaces for testing purposes and can be accessed by the DMA engine 144 through the AXI-based interconnect 124 for efficient data transfers.

In various implementations, block 118 may represent specialized functional units within the SoC architecture 100, such as hardware accelerators, DSPs, or other application-specific processing elements. Generally, block 118 performs dedicated computational tasks that benefit from hardware specialization, such as encryption, video processing, or neural network inference. In aspects, block 118 connects to the AXI-based interconnect 124 through AXI-initiator interfaces, which enables communication with other system components. Block 118 may interact with core clusters A and B (110, 112) and access shared memory 140 through established system protocols, which follow standard data flow patterns within the SoC architecture. In some cases, block 118 may contain its local memory buffers, which minimize external memory access during processing operations.

As depicted, the dedicated memory 120 may be the memory specifically associated with and used by the block 118 through memory dedicated interfaces. In aspects, dedicated memory, such as 120, often includes specialized buffers, lookup tables, or configuration data for specific components and applications. Generally, dedicated memory 120 connects to the AXI-based interconnect 124, which may allow access from multiple system components according to defined permission rules. Dedicated memory 120 may interface with the MBIST controller 126 through other specialized interfaces for testing operations. In various implementations, dedicated memory 120 may be optimized for specific access patterns or data types, which enhances performance for its intended applications. Dedicated memory 120 differs from shared memory 140 in its access patterns and ownership, which typically restricts its usage to predefined components or functions rather than general system allocation.

In aspects, AXI-based interconnect 124 may transport data between various components of the SoC architecture 100 and constitutes part of the communication/interconnect fabric. Generally, AXI-based interconnect 124 forms a comprehensive communication network throughout the SoC architecture 100 by connecting to multiple component types through appropriate interfaces. The AXI-based interconnect 124 may connect to the core clusters A and B (110, 112), block 118, and controllers through AXI-target interfaces. Additionally, it may connect to the combined SMC-DMA unit 138 and the host interface 150 through AXI-initiator interfaces, creating a comprehensive communication network throughout the SoC architecture 100.

In various implementations, AXI-based interconnect 124 may manage multiple simultaneous transactions through separate channels for address and data. The AXI-based interconnect 124 may incorporate arbitration mechanisms that resolve conflicting access requests, ensuring fair resource allocation according to predefined priority schemes. Generally, the AXI-based interconnect 124 supports different transaction types, including single transfers, bursts, and exclusive accesses, providing flexibility for various communication requirements.

In aspects, OCM subsystem 122 may include a combination of on-chip memory resources with memory banks and control logic, which provides shared memory access for use by other components of the SoC architecture 100. Generally, the OCM subsystem 122 includes the combined SMC-DMA unit 138, the SMC 142, the DMA engine 144, and the shared memory 140, collectively forming a memory management solution. The OCM subsystem 122 may utilize memory-dedicated interfaces internally between the SMC-DMA unit 138 and the shared memory 140, thereby eliminating protocol overhead for shared memory operations across the AXI-based interconnect 124.

In various implementations, the Combined SMC-DMA unit 138 may integrate shared memory controller (e.g., SMC 142) functionality with direct memory access capabilities, representing a departure from preceding separate controller architectures. Generally, the SMC 142 functions as a memory controller that manages access to the shared memory 140 by handling address decoding, bank selection, and access arbitration between multiple requestors within the OCM subsystem 122. In aspects, the SMC 142 implements memory controller functions, including request queuing, timing control, and data path management to coordinate read and write operations from various system components.

In aspects, combined SMC-DMA unit 138 may manage access to shared memory 140 through memory dedicated interfaces, which provide direct, high-throughput data paths. Generally, the combined SMC-DMA unit 138 connects to the AXI-based interconnect 124 through AXI-target and AXI-initiator interfaces. Additionally, the combined SMC-DMA unit 138 may interface with the DMA interconnect 146 through specialized interfaces, which enable efficient memory-to-memory operations across distributed memory subsystems throughout the SoC architecture 100.

Preceding memory testing implementations may exhibit limitations in timing closure and physical implementation that result from the insertion of multiplexers at memory boundaries, which introduce signal propagation delays in functional paths and create routing congestion when memory blocks occupy dense silicon areas. Preceding MBIST controller architectures typically require centralized test logic that connects to distributed memory components across the chip through dedicated wiring paths, which increases routing complexity in proportion to the number of memory instances. This may create implementation challenges that scale negatively with memory density and distribution patterns.

In aspects, shared memory 140 may provide a common storage area that multiple system components can access, serving as both a communication medium and a data repository for the SoC architecture 100. Generally, shared memory 140 often includes Static Random Access Memory (SRAM) arrays that deliver performance characteristics superior to those of off-chip alternatives, enabling time-sensitive operations to execute within optimal temporal parameters. Shared memory 140 may interface with the MBIST controller 126 through the DMA interconnect 146, which facilitates comprehensive testing capabilities without requiring additional dedicated test connections.

In various implementations, the shared memory 140 may include memory banks that operate as independently accessible units, enabling simultaneous memory access operations across the OCM subsystem 122. These memory banks may implement an organizational structure that divides the SRAM arrays into multiple sectors, which permits simultaneous read and write operations to different sectors without contention. Generally, the structure employs address-based partitioning, which creates non-overlapping memory regions, thereby simplifying direct addressing by the DMA engine 144.

In aspects, each bank may contain a dedicated control circuitry that manages timing and access arbitration, allowing multiple concurrent operations from different requestors. The memory bank design may incorporate bank-specific data paths that connect directly to the internal routing infrastructure, which minimizes latency for intra-bank transfers. This segmented arrangement may facilitate memory-to-memory operations that remain within the OCM subsystem 122, which eliminates unnecessary data movement through the AXI-based interconnect 124.

Preceding DMA operations demonstrate performance limitations when transferring data between on-chip memories. With previous designs, a DMA controller must execute a read operation traversing the AXI interconnect 124 to access source memory, followed by a write operation again traversing the AXI interconnect 124 to reach destination memory. This dual-traversal pattern creates latency increases and bus contention, as preceding DMA controllers access all memory resources through the shared AXI interconnect 124 rather than maintaining direct pathways.

In aspects, DMA engine 144 may be part of the combined SMC-DMA unit 138, which represents a departure from preceding architecture where the functionality of the SMC and DMA controllers is separate. Generally, the DMA engine 144 executes direct memory access operations without CPU intervention, which offloads memory-intensive tasks from the processor. The DMA engine 144 may connect directly to shared memory 140 through internal paths within the SMC-DMA unit 138, which eliminates unnecessary data movement through the AXI interconnect for operations involving shared memory. In various implementations, the DMA engine 144 determines optimal data paths for memory operations based on target memory locations, thereby enhancing system performance by minimizing unnecessary data movement. It may execute memory-to-memory operations by transferring data directly between memory banks through an OCM-internal path 152, which maintains data flow within the OCM subsystem.

DMA architectures may implement standardized interface protocols that define communication mechanisms between DMA controllers and memory subsystems through specialized read and write interfaces, which incorporate control signal sequences including write request and grant handshaking, data transfer protocols that manage address, length, identification tracking, and completion status reporting mechanisms that coordinate memory-to-memory operations. These interface specifications may establish the communication framework that enables DMA operations, where the protocols function through a general-purpose AXI interconnect rather than direct memory controller integration pathways.

In aspects, DMA engine 144 may intercept and analyze memory access requests to direct traffic appropriately, implementing decision-making processes that differentiate between operations targeting shared memory 140, other on-chip memories, or external host memory 134. Generally, DMA engine 144 directs memory operations between banks via the OCM-internal path 152 that connects DMA directly to banks within the OCM subsystem 122. DMA interconnect 146 may implement a daisy-chain topology that links memory subsystems based on their physical proximity, thereby facilitating timing closure and reducing wiring complexity. In various implementations, DMA interconnect 146 may provide dual functionality by serving both functional DMA operations and MBIST testing, which leverages similar access patterns to reduce overall system complexity. Alternatively or additionally, the DMA interconnect 146 may implement a low-power interface (e.g., clock stopping, reduced clocking) with the SMC 142 to reduce power consumption with DMA operations are not being executed or when the SMC can operate with lower performance requirements.

MBIST controller 126 performs memory built-in self-test operations for all on-chip memories, detecting manufacturing defects and operational failures. Preceding MBIST architectures implement centralized test logic connecting to distributed memory components through specialized testing pathways (bar 148), providing direct access to memories while bypassing standard protocols. These MBIST insertion positions multiplexers at memory boundaries, intercepting functional signal paths and introducing signal propagation delays that create timing constraints scaling with memory density.

The MBIST controller architecture may generate systematic test patterns through write-read-compare sequences that identify manufacturing defects, including stuck-at faults, coupling faults, and address decoder failures, while the specialized testing pathways represented by bar 148 traverse the chip to establish connections with all memory components. The physical implementation may create routing congestion that affects layout decisions, where the preceding MBIST controller architecture must maintain connections to distributed memory subsystems through pathways that compound routing complexity.

In aspects, the MBIST controller 126 may connect to the DMA interconnect 146 through specialized interfaces, which provide access to distributed memory subsystems throughout the SoC architecture 100. Generally, the MBIST controller 126 interfaces with the TAP controller 132 through specialized interfaces, which enable external control and observation of memory test operations. The MBIST controller 126 may use the DMA interconnect 146 as a shared path for testing, which reduces the overhead associated with preceding MBIST insertion approaches that require dedicated multiplexer structures at each memory boundary.

In various implementations, direct-connect-indicating bars 128A, 128B, 130A, and 130B may represent physical connections between the DMA interconnect 146 and low-latency memories that create direct memory interfaces, bypassing the AXI-based interconnect 124. Bars 128A and 128B may specifically indicate connections to low-latency memory A 114 serving core cluster A 110, while bars 130A and 130B indicate connections to low-latency memory B 116 serving core cluster B 112. These interfaces may implement a shared bus insertion approach for MBIST, positioning test access points away from timing-critical paths.

In aspects, TAP controller 132 may manage test access port functions. Generally, the TAP controller 132 implements the Institute of Electrical and Electronics Engineers (IEEE) 1149.1 standard interface that provides standardized methods for accessing internal test and debug features. TAP controller 132 may connect to external test equipment through the JTAG Test/Debug interface 136 using specialized interfaces that enable boundary scan testing, internal scan chain access, and debug operations, while TAP controller 132 interfaces with test structures within the SoC, including the MBIST controller 126, through specialized interfaces for coordinated testing. In various implementations, TAP controller 132 operates as a finite state machine that responds to external control signals, which direct test data to internal registers and scan chains. TAP controller 132 may support manufacturing test functions and in-field debugging capabilities, extending SoC testability throughout operational lifecycles.

In aspects, JTAG Test/Debug 136 interface may serve as the external physical interface that implements the JTAG protocol, which provides standardized access to testing and debugging facilities of SoC architecture 100, where this interface consists of dedicated pins including Test Data In (TDI), Test Data Out (TDO), Test Clock (TCK), and Test Mode Select (TMS) that collectively enable boundary scan operations and access to internal test structures. Generally, JTAG Test/Debug interface 136 connects to TAP controller 132 within the SoC through specialized interfaces that create communication pathways between external test equipment and the chip's internal test/debug infrastructure.

In various implementations, JTAG Test/Debug interface 136 may support operations including manufacturing tests, in-field diagnostics, device programming, and software debugging that extend lifecycle management capabilities of SoC architecture 100, where industry professionals utilize JTAG Test/Debug interface 136 during silicon validation, board testing, and field troubleshooting. Generally, the standardized nature of JTAG Test/Debug 136 interface enables compatibility with test equipment across the semiconductor industry, which simplifies integration into automated test environments.

In aspects, host interface 150 may enable communication between SoC architecture 100 and external systems, where host interface 150 implements standardized protocols such as Peripheral Component Interconnect Express (PCIe), Universal Serial Bus (USB), or proprietary interfaces that establish methods for data exchange. Generally, host interface 150 connects to AXI-based interconnect 124 internally through AXI-target interfaces and to host memory 134 externally via specialized interfaces that establish bridges between the SoC and external computing resources. Host interface 150 may manage data transfers, considering bandwidth, latency, and protocol requirements to optimize communication efficiency.

In aspects, host memory 134 may function as an external main memory resource that supplements the SoC architecture 100, providing storage capacity that exceeds on-chip memory components by measurable factors. Generally, host memory 134 constitutes part of the memory that resides outside the SoC's physical boundaries, creating a hierarchical memory structure in the overall system design. Host memory 134 may store application code, operating system components, and data sets that exceed the on-chip memory capacity, enabling software execution without silicon area constraints of integrated memory. In various implementations, host memory 134 operates with access latency that exceeds on-chip memory resources by quantifiable factors, creating performance considerations.

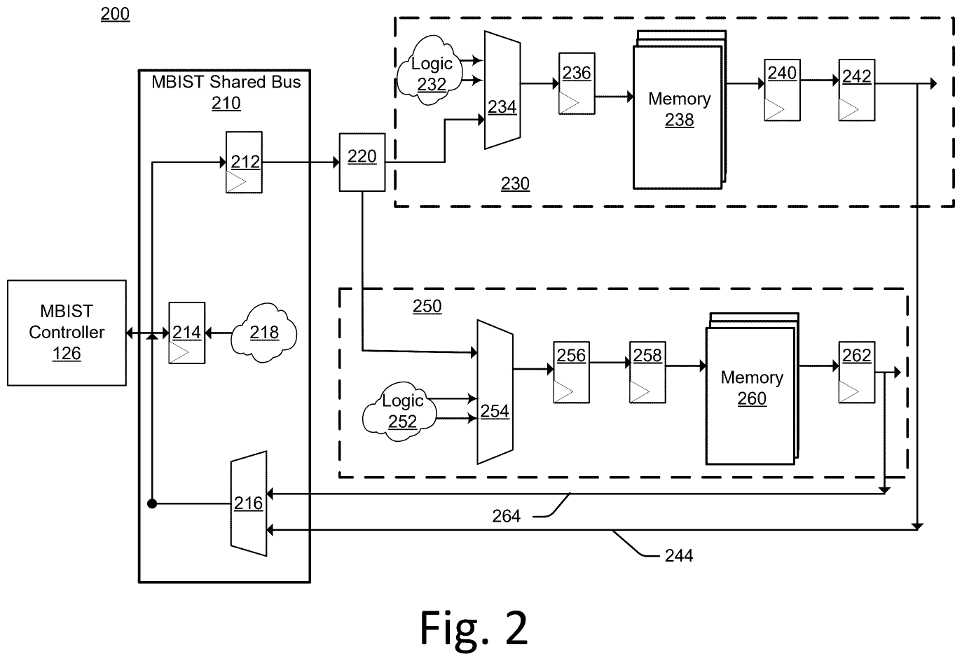

FIG. 2 illustrates a functional depiction of an MBIST shared-bus insertion test architecture 200 that can be implemented in a suitable SoC architecture, such as SoC architecture 100. The MBIST shared-bus insertion architecture 200 can enable a testing framework that connects a centralized test controller (e.g., MBIST controller 126) to multiple memory blocks through a common interface. This approach places test access points at locations that avoid direct interference with memory interface signals. The MBIST shared-bus insertion test techniques may employ a shared bus structure that reduces the number of test-specific connections compared to preceding methods that insert multiplexers on each memory signal path. Test stimuli flow from the controller to memories through registered interfaces, which maintain separation between the test and functional domains.

The MBIST shared-bus insertion architecture 200 can provide distinct pathways for test patterns and responses that operate alongside normal memory access routes. Memory testing proceeds through standardized interfaces that accommodate different memory configurations without customized test logic for each instance. This technique streamlines the physical implementation requirements that typically complicate designs with multiple embedded memory arrays. The MBIST shared-bus insertion architecture 200 supports comprehensive memory testing capabilities while maintaining the signal integrity requirements that determine system performance specifications.

The MBIST shared-bus insertion architecture 200 includes several interconnected components that cooperate to enable memory testing while preserving normal system operation capabilities. As depicted, the MBIST shared-bus insertion architecture 200 includes the MBIST controller 126, an MBIST shared bus 210, an MBIST input interface 220, dataflows (such as a read-dominant dataflow 230, and a write-dominant dataflow 250).

Test operations with the MBIST shared-bus insertion architecture 200 may start with with the MBIST controller 126, which generates memory test patterns that detect manufacturing defects in OCM arrays. Memory test patterns include predetermined sequences of addresses, data values, and control signals that systematically exercise memory cells according to established test algorithms. These patterns include marching patterns that sequentially write and read alternating values, checkerboard patterns that create adjacent cell stress conditions, and galloping patterns that identify address decoder faults.

The MBIST controller 126 connects to the MBIST shared bus 210, which contains three primary components: a top register 212, a bottom register 214, and a multiplexer 216. The DMA interconnect 146 serves as the physical pathway that enables the MBIST shared bus 210 functionality. The DMA interconnect is the transport layer, while the MBIST shared bus is the protocol/logical layer that uses that transport.

The top register 212 receives and latches test stimuli from the MBIST controller 126, which provides stable signal values that propagate to subsequent test components. The bottom register 214 captures memory test response data that returns from tested memory components, which enables comparison operations that identify discrepancies between expected and actual values. The multiplexer 216 selects which memory component's output data reaches the bottom register 214 during testing operations, which allows multiple memory instances to share the test infrastructure.

A handshaking logic 218 establishes synchronization between the MBIST controller 126 and the MBIST shared bus 210, which ensures proper timing relationships for data transfers. The handshaking logic 218 generates and interprets control signals that coordinate the movement of test patterns from the controller to the top register 212, which prevents data corruption that might result from timing violations. The handshaking mechanism implements a request-acknowledge protocol that maintains data integrity throughout test sequences, which proves particularly valuable when testing memory components that operate in different clock domains.

The MBIST input interface 220 distributes test stimuli from the top register 212 to memory subsystems within the SoC architecture. This interface forms the initial segment of dual-mode signal paths that support two distinct operational states. Dual-mode signal paths serve as communication channels that transmit either functional data during normal system operation or test patterns during diagnostic procedures without requiring physical reconfiguration. These paths utilize multiplexers at strategic locations that select between functional and test inputs based on a mode control signal, which eliminates the need for separate dedicated test connections to each memory component.

Functional data transfers involve the movement of operational information between processing elements and memory components during normal system activities within the SoC architecture 100. For example, a functional data transfer occurs between core clusters (core cluster A 110 and core cluster B 112) and their associated memory components, which include low-latency memory A 114 and low-latency memory B 116. The functional data transfers encompass instruction fetches that retrieve program code from shared memory 140, which provides common storage accessible by multiple system components.

Functional data transfers include data read and data write operations. Data read operations access information stored in dedicated memory 120, which supports specialized processing requirements of functional blocks. Write transactions update memory contents within the OCM subsystem 122 based on computation results, which alter stored values according to algorithmic outcomes. The combination of these operations creates continuous data movement patterns between processing elements and memory components, which necessitates unimpeded signal paths that maintain maximum performance characteristics. The direct memory connections established between core clusters and their respective low-latency memories enable high-speed access that bypasses the AXI-based interconnect 124, which reduces latency for time-sensitive operations. The separation of functional paths from test infrastructure preserves these performance characteristics, allowing normal system activities to proceed without the timing degradation that would otherwise result from direct test logic insertion.

The MBIST shared-bus insertion architecture 200 implements specialized dataflow structures that accommodate different memory access patterns. The read-dominant dataflow 230 is an example of one, and it includes components that optimize paths for frequent data retrieval operations. The read-dominant dataflow 230 includes functional logic 232 that generates operational address and control signals, functional mux 234 that selects between normal and test inputs, a single memory-component input register 236 that buffers incoming signals, memory component 238 that stores digital information, dual memory-component output registers 240 and 242 that capture read data, and MBIST data-out path 244 that returns test responses to the MBIST shared bus 210.

Memory components (such as memory component 238) constitute the storage arrays that maintain digital information within the system. These components include SRAM (Static Random-Access Memory) arrays, which provide fast access times without requiring refresh, register files that store temporary data for processing units, and specialized buffers that support specific operations. During operation, these components receive address and data inputs that specify storage locations and values, and they produce output data that corresponds to addressed memory locations during read operations.

The read-dominant dataflow 230 employs a single-input register configuration with dual output registers, creating a heavily pipelined output path. This configuration supports application scenarios that require efficient data retrieval and distribution, which include cache memory subsystems that supply instructions and data to processing units, lookup tables that provide transformation values for computational operations, and content-addressable memories that facilitate rapid search functionality. The dual output registers stabilize data for downstream logic elements, which reduces timing violations that might occur with complex distribution networks.

The write-dominant dataflow 250 implements an architecture optimized for precise write timing control. The write-dominant dataflow 250 includes functional logic 252 that generates operational signals, functional mux 254 that selects operation mode, dual memory-component input registers 256 and 258 that create a heavily pipelined input path, memory component 260 that stores information, a single memory-component output register 262 that captures read data, and MBIST data-out path 264 that returns test responses. The dual-input register configuration ensures precise timing for signals entering the memory component, accommodating longer or more complex input paths that characterize write-intensive applications.

The MBIST shared-bus insertion architecture 200 implements two operational modes that operate through identical physical signal paths. Normal operation mode refers to the state in which the system executes its designed application functions, encompassing data access between processing elements and memory storage. During this operational state, functional logic 232 and 252 produce memory access signals that travel through functional multiplexers 234 and 254, which select the functional input connection. These signals proceed through memory-component input registers 236, 256, and 258 to memory components 238 and 260, which subsequently generate output data that passes through memory-component output registers 240, 242, and 262 back to the respective functional logic. The normal operation mode maintains direct signal connections, resulting in unimpeded data transmission paths that support computational operations performed by core clusters A and B.

Test mode functions as a diagnostic state, during which memory verification procedures occur. During this operational configuration, the MBIST controller 126 executes test sequences that systematically evaluate memory cells to identify manufacturing anomalies. The controller adjusts functional multiplexers 234 and 254 to select the test input channel, which directs test patterns from the MBIST input interface 220 to memory components 238 and 260. Memory test response data comprises binary values extracted from memory cells during verification procedures, which flows through MBIST data-out paths 244 and 264 to multiplexer 216. The MBIST controller 126 obtains this data from bottom register 214 and conducts a bit-by-bit comparison against reference values stored in internal registers, which identifies any variances that indicate structural defects within the storage array.

Memory failures appear in multiple forms that correspond to distinct physical abnormalities in components such as memory 238 and 260. Stuck-at faults develop when memory cells within memory component 238 cannot transition between logical states regardless of write instructions, which creates consistent discrepancies during data retrieval through output registers 240 and 242. Coupling faults result from electrical interference between proximate memory cells in memory component 260, which causes state changes in neighboring cells during write operations. Address decoder failures prevent accurate selection of memory rows or columns in both memory components 238 and 260, which leads to data retrieval from incorrect memory locations. Pattern-sensitive faults emerge when specific data configurations stored within the memory array generate interference conditions that modify stored values, which become detectable when the MBIST controller 126 performs comparison operations between expected and actual data patterns.

The MBIST shared-bus insertion architecture 200 maintains direct signal connections between functional logic 232, 252, and memory components 238, 260 throughout both operational modes. Direct signal connections provide uninterrupted electrical pathways without multiplexers positioned on timing-critical routes, thereby preserving signal transmission characteristics that determine the system's operating frequency. Preceding MBIST methodologies position multiplexers directly within functional paths between core clusters 210, 212, and their corresponding memory elements, which introduces propagation delays that reduce maximum clock frequencies. The shared-bus approach locates multiplexers 234, 254 away from timing-constrained paths, which eliminates these timing penalties and sustains the high-bandwidth connections that characterize the SoC architecture 100.

During transitions between normal operation mode and test mode, the architecture preserves the electrical properties of signal pathways, which prevents alterations in timing parameters. The mode transition occurs through selection state changes in functional multiplexers 234 and 254 rather than physical circuit reconfiguration, which enables seamless switching between functional and test states. This implementation method allows test capabilities to coexist with the full-performance operation of memory components 238 and 260, maintaining system operating frequency specifications regardless of the presence of test infrastructure. The handshaking logic 218 manages these mode transitions, which ensures proper timing synchronization between the MBIST controller 126 and the memory components undergoing evaluation procedures.

The operational sequence of the MBIST shared-bus insertion architecture 200 demonstrates the practical implementation of dual-mode functionality. During test initialization, the MBIST controller 126 generates memory test patterns that are transferred to the top register 212 through coordinated handshaking operations. These patterns travel through the MBIST input interface 220 to functional multiplexers in both dataflow paths, which direct signals to memory components for execution. Response data returns through output registers and MBIST data-out paths to the multiplexer 216, which selects the appropriate data stream for storage in the bottom register 214. The MBIST controller 126 retrieves this data for comparative analysis, which generates pass/fail status indicators for each memory location that undergoes verification.

This architectural approach reduces implementation complexity when compared to preceding methodologies. The decreased quantity of test-specific signal paths reduces wiring density in memory-dense regions, simplifying physical placement and routing procedures. The standardized test interfaces support multiple memory configurations within a common test framework, providing consistent test coverage across diverse memory architectures found in modern system-on-chip designs. The read-dominant dataflow 230 and write-dominant dataflow 250 configurations accommodate different memory access patterns, which enables comprehensive testing of various memory subsystems through a unified test methodology.

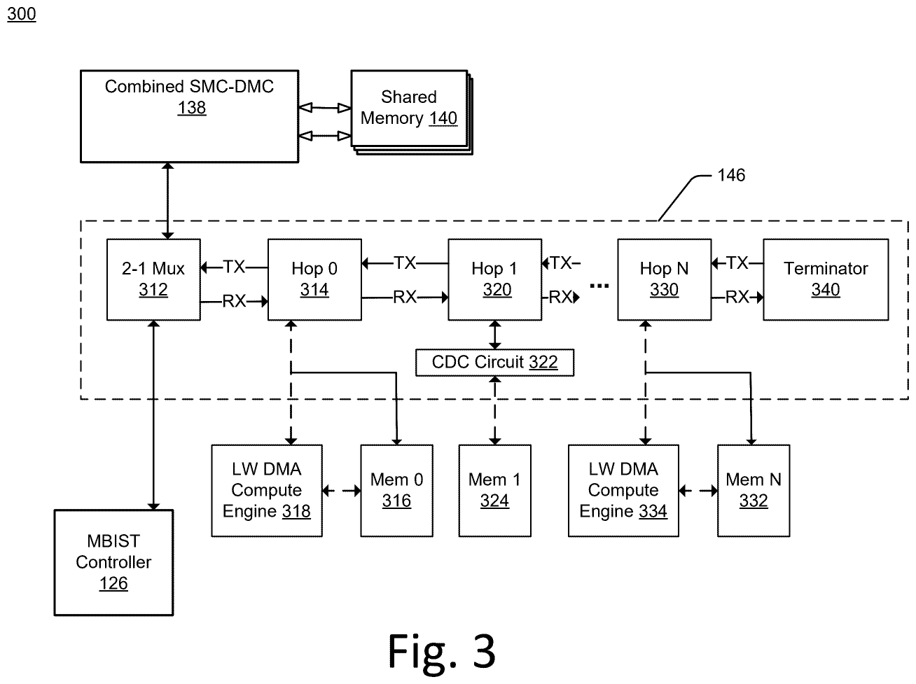

FIG. 3 illustrates an operating environment 300 for an implementation of the DMA interconnect 146. As depicted, the DMA interconnect 146 includes 2-1 mux 312, Hop 0 314 with associated light-weight (LW) DMA compute engine 318 and connected memory (Mem 0) 316, Hop 1 320 with associated clock domain crossing (CDC) circuit 322 (CDC 322) and connected memory (Mem 1) 324, Hop N 330 with associated the LW DMA compute engine 334 and connected memory (Mem N) 332, and terminator 340.

As depicted, the DMA interconnect 146 is implemented as a daisy-chain topology that connects distributed memory subsystems across a SoC architecture, such as SoC architecture 100. The DMA interconnect 146 begins with a 2-1 multiplexer 312, which functions as a signal selection circuit that accepts two input signals and produces one output signal based on a selection control. This multiplexer receives inputs from two initiator interfaces: one from the combined SMC-DMA unit 138 and one from the MBIST controller 126. The selection mechanism determines which initiator accesses the communication pathway, which enables the physical infrastructure to support both memory operations and testing procedures through a shared channel.

The DMA interconnect 146 extends through multiple “Hop” nodes, which serve as connection points in the daisy chain that relay data between segments of the interconnect. Hop 0 314 operates as the initial node in the sequential chain, which contains transmit (TX) and receive (RX) interfaces that handle bidirectional data communication. These interfaces process outgoing data that travels toward subsequent hops and manage incoming data that returns from downstream elements. Hop 0 314 connects to the LW DMA compute engine 318, which operates as a distributed processing unit that executes memory operations locally without requiring intervention from the central controller.

The LW DMA compute engine 318 interfaced with Hop 0 314 provides computational capabilities at the associated memory location (e.g., Memory 0 316). The LW DMA computing engine 318 executes data transfer commands, performs data manipulation operations such as XOR or hashing, and manages local memory access to Memory 0 316. The distributed architecture of these LW DMA compute engines reduces data movement across the interconnect by processing operations at the source or destination memory rather than routing data through a central controller. Memory 0 316 represents a specific memory subsystem that stores digital information, which connects to the DMA interconnect 146 through the LW DMA compute engine 318.

In aspects, a DMA engine (e.g., light-weight DMA engine, not shown) can be implemented in Hop 0 314 such that the DMA engine 144 can send a DMA command to Hop 0 instead of sending a memory read request. The DMA engine in Hop 0, in response to receiving the DMA command, can then issue a direct memory read to the memory connected to Hop 0 314 and send a memory write request to the memory connected to Hop 1 320, Hop N 330, or any other Hop. With this approach of distributed light-weight DMA, the data is can be moved from Hop 0 314 to Hop N (or any other Hop), thereby increasing performance and significantly reducing power consumption. Based on system silicon area or power budget design parameters, the system may implement an instance of a light-weight DMA engine in selected Hops or all Hops.

With reference to AXI interconnect transactions, an AXI interconnect is typically configured with a fixed or static size limit of 4 KB per transaction. In aspects of a shared memory controller with DMA, however, the DMA interconnect 146 may support configurable and/or dynamic adjustment of DMA size or lengths on a per transaction basis. In other words, the DMA engine 144 may dynamically set, configure, or adjust the length or size of DMA transactions to increase or optimize performance of the DMA interconnect.

The second node, Hop 1 320, demonstrates an alternative implementation that connects to a CDC circuit 322, rather than a compute engine. The CDC circuit 322 may include synchronization registers and control logic that manage signal transitions between regions operating at different clock frequencies. Thus, the CDC circuit 322 enables reliable data transfer between the DMA interconnect 146 and Memory 1 324 when these components operate with different timing characteristics. Memory 1 324 constitutes another memory subsystem that stores digital information, which connects to the DMA interconnect 146 through the CDC circuit 322.

There may be several other hops in the chain that eventually end with Hop N 330, which connects to another LW DMA compute engine 334 that interfaces with Memory N 332. This configuration mirrors the implementation at Hop 0, which demonstrates the architecture's application pattern across multiple memory subsystems. The chain concludes with a terminator 340, which consists of electrical components that absorb signal energy at the endpoint of the transmission line. This termination prevents signal reflections that could create interference patterns and corrupt data transmission.

The combined SMC-DMA unit 138 connects to the DMA interconnect 146 through one input of the 2-1 multiplexer 312. This controller generates memory access commands that travel through the daisy chain to target memories. When operations involve memory subsystems connected to the DMA interconnect 146, the LW DMA compute engines execute these operations at the memory location. For example, a data transfer command between Memory 0 316 and Memory N 332 activates the respective compute engines (318 and 334), which manage the operation locally and eliminate data travel back to the central controller.

The MBIST controller 126 connects to the other input of the 2-1 multiplexer 312, which allows memory testing procedures to utilize the same physical communication pathway. The controller transmits test patterns through the DMA interconnect 146, which propagate to target memories for fault detection. Test responses travel back through the same pathway, which completes the verification cycle. This shared infrastructure approach eliminates requirements for dedicated test connections to each memory subsystem, which reduces implementation complexity.

The variable implementation of light-weight DMA compute engines versus CDC circuits demonstrates the architecture's adaptation to specific requirements of different memory subsystems. Memory subsystems that benefit from local processing capabilities connect through compute engines, while memory subsystems that operate in different clock domains connect through CDC circuits. This configuration provides appropriate interface mechanisms for each memory subsystem without unnecessary hardware overhead.

The DMA interconnect 146 creates a pathway that serves both functional operations and memory testing procedures, which consolidates infrastructure requirements. The shared communication channel enables comprehensive memory verification without the need for multiplexers to be inserted directly in timing-critical paths, thereby preserving signal integrity characteristics. Memory-to-memory data transfers proceed through optimized pathways, which reduce contention on the main system interconnect for memory-intensive operations.

Preceding SoC architectures typically implement separate logic blocks for memory initialization and scrubbing management within memory controllers. Memory initialization blocks contain address counters, data generators, and control state machines. Scrubbing management blocks perform periodic read-modify-write operations across memory regions, detecting and correcting single-bit errors before they accumulate into uncorrectable multi-bit errors.

These preceding approaches require dedicated circuitry, specialized data paths, and independent control logic. They connect directly to memory banks through interfaces operating separately from normal access channels. This creates redundant structures that multiply connection requirements and demand additional registers, configuration storage, and coordination mechanisms.

The combined SMC-DMA unit 138 eliminates these separate dedicated blocks by integrating memory initialization and scrubbing functions into the Data Processing Engine (DPE) command structure. The combined SMC-DMA unit 138 reuses existing DMA infrastructure within the OCM subsystem 122 to perform maintenance operations through shared command processing pathways.

Table 1 presents an example of a DPE command structure that enables the SMC-DMA unit 138 to execute memory-specific operations through a unified 32-bit command format. This consolidates memory maintenance, computational, and testing functions within the OCM subsystem 122 through standardized binary encoding fields.

TABLE 1
DPE COMMAND STRUCTURE

| DW | FIELD | SIZE (bits) | DESCRIPTION |
|---|---|---|---|
| 0 | TAG | 31:16 | Software assigned Tag value used to identify this command. Hardware |
| | | | copies this value to the TAG field in the Completion Queue |
| | SKIP_DPE_ELMNT | 15 | When this bit is set, no DPE operation is performed. A completion queue |
| | | | element is generated with the DPE_ELMNT_SKIPPED bit set |
| | DMA_OPCODE | 14:13 | 0h: Read from SRC and write to DST |
| | | | 1h: Memory SRC read only (For memory scrubbing, look-up or searching) |
| | | | 2h: Memory DST write only (For initialization or memory scrubbing) |
| | | | 3h: Reserved |
| | DST_PRP_SGL_SLCT | 12 | 0h: PRP format; 1h: SGL format |
| | SRC_PRP_SGL_SLCT | 11 | 0h: PRP format; 1h: SGL format |
| | RSVD | 10:9 | Reserved |
| | WRT_OPCODE | 8:7 | 0h: All zero write |
| | | | 1h: All one write |
| | | | 2h: Zero-byte write |
| | | | 3h: Reserved |
| | XOR_OPCODE | 6:4 | 0h: No additional computing operation (no XOR, AND, OR, CMP . . . ) |
| | | | 1h: XOR |
| | | | . . . |
| | HASH_OPCODE | 3:0 | Determines the type of HASH operation: |
| | | | 0h: No HASH 1h: SHA-1 2h: SHA-224 3h: SHA-256 |
| | | | 4h: SHA-384 5h: SHA-512 |
| | | | 6h-Fh: Reserved |

This architectural integration consolidates memory initialization, scrubbing, and computational operations into unified command frameworks. The shared register structures and interface mechanisms reduce silicon area requirements while simplifying the controller architecture. This eliminates the isolated functional blocks that preceding memory controller designs require for specialized memory operations. Memory initialization utilizes the existing zero/one-fill capabilities of the DPE, as shown in Table 1. Patrol scrubbing operations implement read-only commands that trigger inline scrubbing processes. Zero-byte commands issue dummy writes that activate atomic Read-Modify-Write operations within the memory banks.

The DMA engine 144 can execute these memory-specific operations through the OCM-internal path 152. This path connects the combined SMC-DMA unit 138 directly to memory banks within the OCM subsystem 122. The approach bypasses the AXI-based interconnect 124 for intra-OCM memory-to-memory operations. Memory initialization operations utilize zero/one-fill capabilities within the DMA engine 144. The engine connects through the OCM-internal path 152 to memory banks within the OCM subsystem 122. This eliminates separate initialization manager blocks that preceding SoC architectures implement as standalone functional components.

Patrol scrubbing operations execute through read-only command functionality that triggers inline scrubbing processes within memory banks. The DMA engine 144 routes operations through the OCM-internal path 152 to replace separate scrubbing manager components with integrated memory maintenance operations. Zero-byte command implementation issues dummy write operations that activate atomic Read-Modify-Write operations within the SMC-DMA unit 138. This integrates with existing memory bank structures through connections that enable memory maintenance functions to reuse existing circuitry within the OCM subsystem 122.

The MBIST controller 126 optimization separates shared bus interfaces into distinct write and read paths. These connect to DMA Read Interface and DMA Write Interface components, creating distinct channels for test stimulus and response data through the DMA interconnect 146. This reduces wiring requirements. Multiplexing operations join MBIST pathways with standard DMA interfaces through connection points. These route signals between multiple processing units and the DMA engine 144. This creates multiplexed pathways that reduce wire connections while maintaining functional separation for memory testing operations that share resources with normal memory-to-memory operations.

Register stages between DMA interfaces and memory components create pipeline stages that add one clock cycle latency while separating timing domains. The SMC-DMA unit 138 accommodates this latency through arbitration structures that manage access timing between functional and test operations. The implementation integrates separate interfaces for test response data and stimulus delivery with existing arbitration logic within the SMC-DMA unit 138. This enables functional and test operations to share common pathways through the OCM-internal path 152 without interfering with timing requirements. Double-buffered components separate timing domains, facilitating the integration of test operations with different timing characteristics from normal memory access patterns.

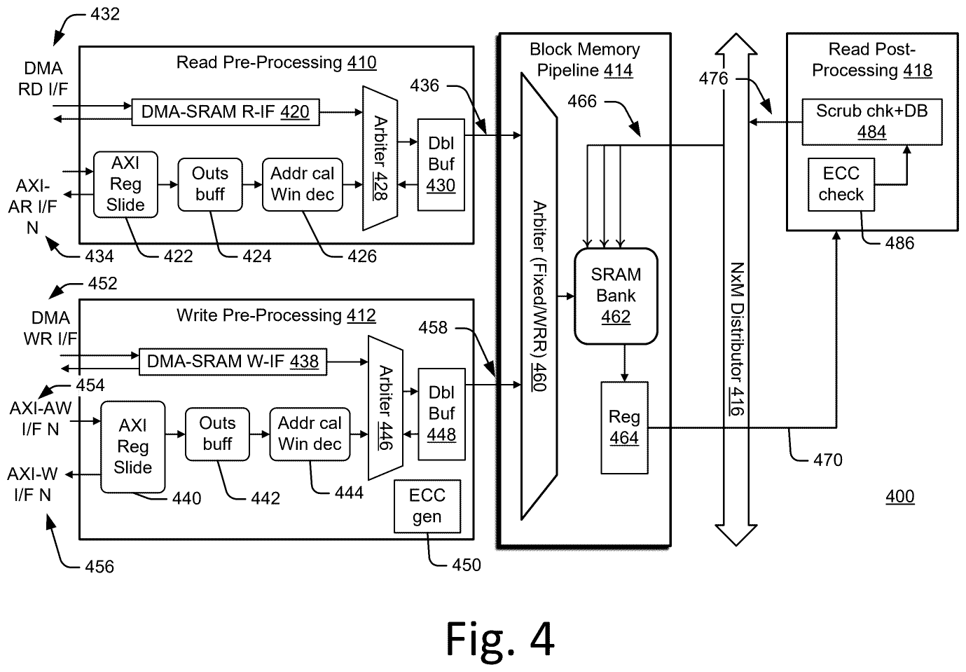

FIG. 4 illustrates a consolidated memory controller architecture 400, which is part of an implementation of the SMC-DMA unit 138, utilizing DPE commands such as those listed in Table 1. The consolidated memory controller architecture 400 integrates patrol scrubbing and memory initialization within the OCM subsystem 122. Unlike the separate dedicated logical blocks of the preceding approaches, the consolidated memory controller architecture 400 provides unified processing pathways for consolidated memory access, error detection, correction, and maintenance operations.

The consolidated memory controller architecture 400 integrates register stages between DMA interfaces and memory components, creating pipeline stages with a one-clock-cycle latency. These separate timing domains through sequential data capture mechanisms. The SMC-DMA unit 138 accommodates this latency through arbitration structures that manage access timing between functional and test operations, utilizing either fixed-priority scheduling or weighted round-robin (WRR) algorithms.

The consolidated memory controller architecture 400 combines separate interfaces for test response data and stimulus delivery with existing arbitration logic. This enables functional and test operations to share common pathways through the OCM-internal path 152 without interfering with timing requirements. Double-buffered components separate timing domains and facilitate the integration of test operations with different timing characteristics from normal memory access patterns through alternating buffer stages that maintain a continuous data flow.

Regarding FIG. 4, the consolidated memory controller architecture 400 includes read pre-processing blocks 410, write pre-processing blocks 412, block memory pipeline (blk_mem_pipe [M]) 414, N×M distributor 416, and read post-processing blocks 418. These implement parallel processing pathways with centralized memory access coordination through the integration of AXI and DMA interfaces. The read pre-processing block 410 includes DMA-SRAM read interface (DMA-SRAM R-IF) 420, AXI interface register slide (AXI Reg Slide) 422, outstanding buffer (OUTS buff) 424 with eight-entry capacity (x8), address calculation window decode (Addr cal Win dec) logic 426, arbiter 428, and double buffer 430. The read pre-processing block 410 enables memory initialization operations that utilize zero/one-fill capabilities within the DMA engine 144. The engine connects through the OCM-internal path 152 to memory banks within the OCM subsystem 122.

The DMA read interface (DMA RD I/F) 432 receives memory read requests from the DMA engine 144 through dedicated signal pathways that bypass AXI protocol overhead. The patrol scrubbing operations are implemented through read-only command functionality that triggers inline scrubbing processes within memory banks. The DMA engine 144 routes operations through the OCM-internal path 152 to replace separate scrubbing manager components with integrated memory maintenance operations.

The AXI address read interface N (AXI-AR I/F N) 434 accepts read transaction requests from AXI-based interconnect through standardized protocol channels. Address translation and timing synchronization occur before accessing the memory bank. Output from DMA RD I/F 432 becomes input to DMA-SRAM R-IF 420. This establishes communication pathways between DMA engine 144 and OCM subsystems while enabling SMC-DMA unit 138 to bypass AXI-based interconnect 124 for intra-OCM memory-to-memory operations. The approach eliminates protocol overhead through dedicated signal connections. Output from AXI-AR I/F N 434 becomes input to AXI reg slide 422. The AXI reg slide 422 functions as a pipeline buffer that synchronizes AXI protocol signals between interface inputs and processing components through sequential register stages. It maintains timing relationships across clock domain boundaries while accommodating one clock cycle latency that register stages create between DMA interfaces and memory components.

Output from AXI reg slide 422 becomes input to OUTS buff 424, which queues pending transactions with an eight-entry capacity. The OUTS buff 424 stores transaction identifiers and status information for operations awaiting completion through temporary storage mechanisms. These manage concurrent memory access requests. The OUTS buff 424 supports register structures and interface mechanisms that reduce silicon area requirements. Output from OUTS buff 424 becomes input to Addr cal Win dec logic 426. This translates memory addresses into physical memory bank locations while processing access window parameters through computational circuits. The Addr cal Win dec logic 426 enables proper memory bank selection and timing coordination within architectural integration, consolidating memory initialization, scrubbing, and computational operations into unified command frameworks.

DMA-SRAM R-IF 420 transmits output signals to the arbiter 428. Addr cal Win dec logic 426 transmits secondary input signals to the arbiter 428. These dual signal pathways converge at the arbiter 428. Arbiter 428 arbitrates between DMA pathway requests and AXI pathway requests. This arbitration determines which processing channel receives memory access authorization during each clock cycle. The arbiter 428 resolves access conflicts between multiple concurrent requests. The arbiter 428 implements a fixed or WRR approach to determine processing priority through scheduling mechanisms. The scheduling mechanisms prevent individual channels from monopolizing memory bandwidth. System performance maintenance occurs through latency accommodation structures. These structures manage access timing between functional and test operations within the SMC-DMA unit 138. The arbitration process ensures balanced resource allocation across competing memory access requests. Output from arbiter 428 becomes input to double buffer 430. This provides dual-stage buffering, separating timing domains between interface logic and memory access operations through alternating buffer stages. The double buffer 430 maintains a continuous data flow while accommodating varying signal propagation delays, which facilitates the integration of test operations with different timing characteristics from normal memory access patterns.

Write pre-processing block 412 includes DMA-SRAM write interface (DMA-SRAM W-IF) 438, AXI reg slide 440, OUTS buff 442, Addr cal Win dec logic 444, arbiter 446, double buffer 448, and error correction code (ECC) generator (gen) 450. These enable zero-byte implementation that issues dummy write operations that activate atomic Read-Modify-Write operations within SMC-DMA unit 138. DMA write interface (DMA WR I/F) 452 receives memory write requests from DMA engine 144 through dedicated signal pathways that implement OCM-internal path 152 connections. AXI address write interface N (AXI-AW I/F N) 454 accepts write address phase information from AXI-based interconnect 124. AXI write interface N (AXI-W I/F N) 456 receives write data phase information through standardized AXI protocol channels. Output from DMA WR I/F 452 becomes input to DMA-SRAM W-IF 438. This establishes direct communication pathways between the DMA and memory subsystem for write operations, which process write commands, address specifications, and data payloads through dedicated signal connections.

Output from AXI-AW I/F N 454 and AXI-W I/F N 456 becomes input to AXI reg slide 440, which provides pipeline staging and synchronization for address and data information. Output from AXI reg slide 440 becomes input to OUTS buff 442, which manages write transaction queuing with an eight-entry capacity. Output from OUTS buff 442 becomes input to Addr cal Win dec logic 444. The Addr cal Win dec logic 444 processes virtual-to-physical address mapping and memory region boundary checking through computational circuits.

ECC gen 450 calculates error detection and correction information for outgoing write data streams using mathematical algorithms that compute parity bits and syndrome codes. This creates redundant information alongside the primary data content. Output from DMA-SRAM W-IF 438 becomes direct input to arbiter 446. Output from Addr cal Win dec logic 444 becomes secondary input to arbiter 446. Arbiter 446 arbitrates between DMA pathway requests and AXI pathway requests to determine which processing channel receives memory access authorization during each clock cycle. Output from arbiter 446 becomes input to double buffer 448, which alternates between two buffer stages to maintain continuous data flow through ping-pong buffer mechanisms.

Block memory pipeline block 414 includes an arbiter (fixed/WRR) 460, SRAM bank 462, and SRAM read data output register (reg) 464. The block memory pipeline 414 functions as the central component for coordinating memory access. It receives input signals 436, 458 from multiple channels that include multiple instances of the read pre-processing blocks 410 and the write pre-processing blocks 412.

These channels often compete and thus require arbitration through the arbiter (Fixed/WRR) 460, which implements either fixed-priority scheduling algorithms or WRR algorithms to resolve concurrent access requests. The arbiter (Fixed/WRR) 460 determines which processing channel receives memory access authorization during each clock cycle through priority-based selection mechanisms.

The arbiter (Fixed/WRR) 460 generates output signals that become input to SRAM bank 462, which contains physical memory arrays where data resides. The SRAM bank 462 receives address signals, control signals, and write data from arbitration logic while generating read data outputs through memory cell access operations. These execute within the OCM subsystem 122 through connections that bypass external memory interfaces. SRAM bank 462 produces output signals during read operations that become input to reg 464, which buffers and stabilizes read data signals emerging from SRAM bank 462 through register-based storage mechanisms that maintain data integrity across timing domains. The reg 464 transmits processed information to subsequent read post-processing 418 through signal pathways that carry data streams 470.

Block memory pipeline block 414 implements unified arbitration logic within SMC-DMA unit 138. This enables both functional memory operations and MBIST operations to utilize shared data pathways through OCM-internal path 152. This dual-mode capability eliminates timing interference between normal memory access patterns and diagnostic testing procedures through coordinated resource allocation and synchronized data movement across timing domains. The block memory pipeline block 414 has configurable pipeline stages that accommodate signal propagation delays and synchronize data movement between processing components and central memory storage through intermediate buffer elements.

Read post-processing block 418 includes scrub check with double buffer (Scrub chk+DB) 484 and ECC check 486. The read post-processing block 418 validates data integrity for information retrieved from SRAM bank 462 through mathematical verification algorithms. These detect single-bit errors, identify multi-bit errors, and determine data corruption status. Output from data streams 470 becomes input to ECC check 486, which functions as the initial processing stage that validates data integrity through computational algorithms. These compare calculated ECC values against stored ECC information.

Output from ECC check 486 becomes input to Scrub chk+DB 484, which operates as the secondary processing stage. It monitors data integrity through systematic error detection mechanisms, while providing dual-stage buffering for read data streams via alternating buffer stages that facilitate timing domain separation.

Scrub chk+DB 484 generates scrub request (scrub req) signals 476 when error conditions require memory maintenance operations. These transmit memory maintenance initiation commands indicate when ECC checking operations detect single-bit errors requiring corrective action. Output from scrub req signals 476 becomes input to N×M distributor 416. This includes a signal routing matrix component that manages data flow coordination between N input channels and M output channels through multiplexed pathway selection and switching logic. The internal routing mechanism implements switching logic that enables the selective activation of pathways based on operational requirements and system configuration parameters. The N×M configuration indicates N input channels from post-processing units that connect to M output channels through a routing matrix that reduces wire connections while maintaining functional separation across a distributed memory subsystem architecture.

N×M distributor 416 directs signals to inline scrubbing [N] 466. This provides data for error detection and correction operations within SRAM bank 462 through Read-Modify-Write operations that correct detected errors through automated write-back processes. These restore data integrity within memory cells without interrupting concurrent memory access operations from other processing channels. The feedback mechanism enables memory maintenance operations to execute automatically when errors are detected. This completes the consolidated memory controller architecture 400 through unified processing pathways that eliminate separate dedicated logic blocks and reduce silicon area requirements through shared register structures and interface mechanisms

Techniques of Direct Memory Access with a Shared Memory Controller

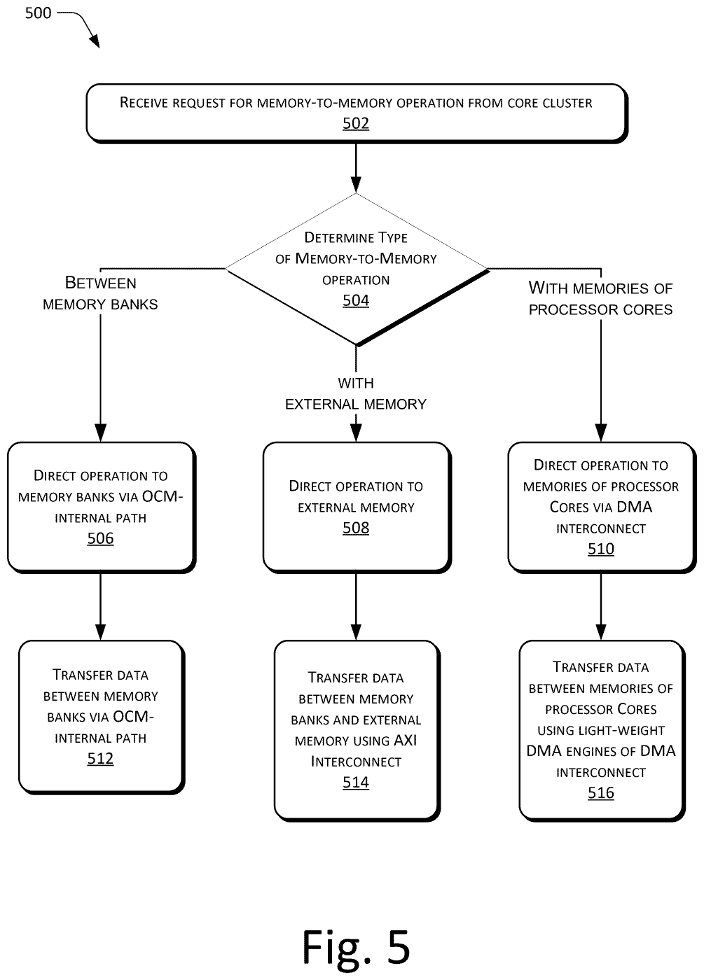

The following discussion describes techniques for the combined SMC-DMA technology, which utilizes direct transfer paths to address inefficient memory-to-memory operations by integrating DMA functionality into an SMC. These techniques may be implemented using any of the environments and entities described herein, such as the SoC architecture 100, the MBIST shared-bus insertion architecture 200, and the DMA interconnect 146. These techniques include methods illustrated in FIG. 5, which depict a set of operations performed by one or more entities.

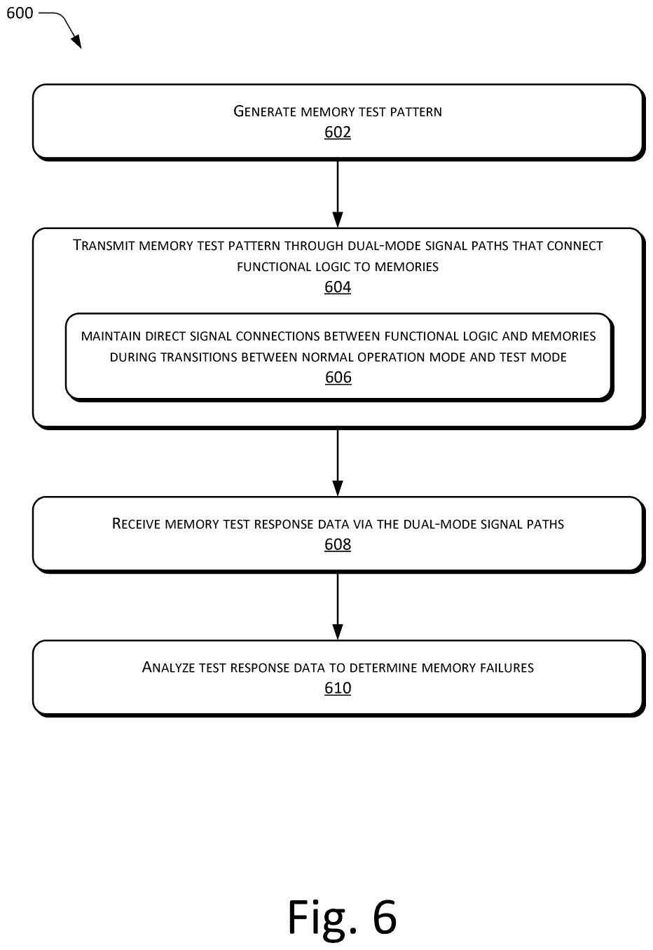

These methods are not necessarily limited to the orders of operations shown in the associated figures. Rather, any of the operations may be repeated, skipped, substituted, or re-ordered to implement various aspects described herein. Further, these methods may be used in conjunction with one another, in whole or in part, whether performed by the same entity, separate entities, or any combination thereof. For example, aspects of the methods described can be combined to implement the combined SMC-DMA technology with direct transfer paths, thereby addressing inefficient memory-to-memory operations by integrating DMA functionality as part of an SMC. Alternatively or additionally, operations of the methods may also be implemented by or with entities described with reference to the System-on-Chip of FIG. 6.

FIG. 5 depicts an example method 500 for implementing combined SMC-DMA technology. The method addresses inefficient memory-to-memory operations by combining DMA functionality as part of an SMC, including operations performed by or with the combined SMC-DMA unit 138, DMA engine 144, DMA interconnect 146, and/or MBIST controller 126.

At 502, a request for a memory-to-memory operation is received by the DMA engine 144 from core clusters (such as core cluster A 110 and core cluster B 112). The core cluster may initiate such a request through control register interfaces that enable software executing on the processing cores to configure transfer parameters, including source addresses, destination addresses, and data lengths. Core clusters submit these commands to the DMA engine 144, which processes the requests to execute memory-to-memory operations without processor core intervention while determining optimal routing paths based on the memory locations involved in the operation.

The DMA engine 144 decodes incoming requests that can include, for example, a 32-bit wide command format that specifies operation parameters. The command processing hardware, which resides within the DMA engine 144, extracts fields that identify the operation type (such as memory copy, fill, or XOR), memory addresses, and transfer size that determine execution parameters.

At 504, the DMA engine 144 determines the type of memory-to-memory operation requested. The DMA engine 144 may accomplish this by analyzing memory addresses to determine their location within the system's memory map. The address evaluation process employs comparison logic that examines address bits, which enables the system to categorize operations based on their memory targets.

If the locations of the memories involved in this operation are internal (e.g., the memory banks of the OCM subsystem 122), the 500 method proceeds to operation 506. If the location of one of the memories involved in this operation is external (e.g., part of host memory 134), the method 500 proceeds to operation 508. If the locations of one of the memories involved in this operation are part of another OCM subsystem (such as other processor memories), then the method 500 proceeds to operation 510.

At 506, when the locations of the memories involved in this operation are internal, the DMA engine 144 directs the memory operation to the memory banks of the OCM subsystem 122 via the OCM-internal path 152 that forms a direct connection between the DMA engine 144 and memory banks within the OCM subsystem 122. The OCM-internal path 152, which can be implemented as a dedicated bus structure, such as the one shown in FIG. 1, connecting the combined SMC-DMA unit 138 to the combined SMC-DMA unit 138, provides data transfer capabilities that bypass the AXI-based interconnect 124. The OCM-internal path 152 may support, for example, data widths of 256 bits, enabling high-bandwidth transfers to memory banks.

At 512, the execution of memory-to-memory operation transfers data via OCM-internal path 152 directly between source and destination memory locations (e.g., the memory banks) that reside within the same OCM subsystem 122, which eliminates the protocol overhead that would otherwise occur through the AXI-based interconnect 124.

At 508, when the location of one of the memories involved in this operation is external, the DMA engine 144 directs the memory operation to the external memory 134 via the AXI-based interconnect 124. The AXI protocol implementation, which may operate with features such as a 128-bit data width and support for burst transfers, creates standardized communication pathways between internal components and external memory resources that reside beyond the SoC boundary.

At 514, the execution of memory-to-memory operation transfers data via the AXI-based interconnect 124 between source and destination memory locations, one of which is the external memory 134.

At 510, when the locations of one of the memories involved in this operation are part of another OCM subsystem (such as low-latency memory A 114 and low-latency memory B 116), the DMA engine 144 directs the memory operation to a memory of another OCM subsystem. These operations traverse the DMA interconnect 146 that appears as connection paths 128A, 128B, 130A, and 130B in FIG. 1. The DMA interconnect 146, which may implement a daisy chain topology that connects memory subsystems in sequence, provides dedicated paths that service both normal data transfers and test operations. Data transfers between subsystems utilize light-weight DMA engines that reside at interconnect nodes.

At 516, the execution of memory-to-memory operation transfers data via the DMA interconnect 146 between source and destination memory locations of other OCM subsystems, such as low-latency memory A 114 and low-latency memory B 116.

In some implementations, the execution of computational functions on data internal to the OCM subsystem 122 is performed by specialized circuits within the combined SMC-DMA unit 138, which processes data while it remains within the OCM subsystem 122. These computational functions include hardware implementations that perform specific operations such as XOR calculations (which combine data streams with bitwise exclusive-OR), CRC computations (which generate cyclic redundancy check values according to polynomial definitions), hash functions (which create fixed-size digests from variable-length inputs), and pattern matching circuits (which identify specific byte sequences within larger data blocks). The computational units access memory through direct paths that connect to the shared memory 140, which allows data to remain localized during processing.

In some implementations, memory maintenance operations may be conducted through the OCM-internal path, which carries specialized commands that manage memory integrity. Memory scrubbing operations, which read memory contents, check for errors, and write back corrected data, utilize the error detection and correction circuits within the combined SMC-DMA unit 138. Memory initialization, which involves writing consistent patterns (such as all zeros or all ones) to memory arrays, employs the DMA fill capability that writes the same value to sequential addresses. These operations utilize the Read-Modify-Write (RMW) circuits, which are represented as logical components of the SMC in the architecture diagrams of FIG. 3.

In addition, memory maintenance operations may include memory diagnostics, in which the MBIST controller 126 may perform memory diagnostic tests, which utilize the DMA interconnect 146 to access memory components throughout the SoC architecture 100. The MBIST controller 126 generates test patterns that include March patterns (which write and read alternating data values in forward and reverse address sequences), checkerboard patterns (which create alternating 0s and 1s in adjacent memory cells), and galloping patterns (which test address decoder functionality). These patterns are transmitted through the MBIST shared bus 210 that incorporates the top register 212 and bottom register 214 components, which capture test stimuli and responses, respectively. Test execution proceeds through dual-mode signal paths that allow both functional data transfers and test operations to utilize the same physical connections, thereby eliminating the need for dedicated test-only wiring. The MBIST controller 126 analyzes test results by comparing expected data against actual read data from memory components, which identifies manufacturing defects such as stuck-at faults (cells that cannot change state), coupling faults (cells that influence adjacent cells), and address decoder failures (incorrect cell selection). The test results are transferred to the TAP controller 132, which communicates with external test equipment through the JTAG Test/Debug interface 136.

FIG. 6 depicts an example method 600 for implementing memory testing with a shared bus, including operations performed by or with the combined SMC-DMA unit 138, DMA engine 144, DMA interconnect 146, and/or MBIST controller 126.

At 602, the MBIST controller 126 (for example, MBIST circuitry) generates memory test patterns that create specific data sequences. These sequences systematically exercise memory cells throughout the respective memories of the one or more processor cores within the SoC architecture 100. The MBIST controller 126 generates test sequences that target different fault models through predetermined bit combinations. These combinations detect manufacturing defects that comprise stuck-at faults, which permanently fix cells at logic zeros and ones, bridging defects that create electrical shorts between adjacent cells, and address decoder failures that produce incorrect cell selection. The pattern generation process utilizes algorithmic approaches that progress through memory addresses in multiple directions. These approaches include marching patterns, checkerboard patterns that create alternating data values in adjacent memory cells, and galloping patterns that systematically test address decoder functionality.

At 604, transmission of test patterns executes through dual-mode signal paths that connect functional logic to the respective memories of the one or more processor cores. These paths serve both functional data transfers during normal operation and test operations during diagnostic procedures. The dual-mode implementation utilizes functional multiplexers strategically placed to select between functional and test data sources based on mode control signals.

At 606, these signals maintain direct signal connections between the functional logic and the respective memories of the one or more processor cores during transitions between normal operation mode and test mode. Test patterns route through the MBIST input interface to memory components through the dual-mode signal paths that function simultaneously for functional data transfers. This routing establishes distinct channels that maintain signal integrity during testing operations. The input path separation employs dedicated registers that establish consistent timing characteristics. Multiple distributed memory subsystems receive test stimuli through the DMA interconnect that connects physically separated memory blocks through unified testing infrastructure.

At 608, reception of memory test response data occurs from the respective memories of the one or more processor cores through the dual-mode signal paths. This reception completes the bidirectional communication channel required for comprehensive testing. The reception hardware includes capture circuits that incorporate memory-component output registers that stabilize data for evaluation. Test response data travels through MBIST data-out paths from the respective memories of the one or more processor cores. The read path implementation utilizes multiplexers in the MBIST shared bus that select between multiple memory response channels. The separation between write and read paths establishes a test infrastructure that preserves signal transmission characteristics and ensures accurate capture of memory cell behavior during test execution.

At 610, analysis of test response data occurs through the MBIST controller 126, which detects memory failures by comparing expected values with actual data returned from the respective memories of the one or more processor cores through the dual-mode signal paths. The analysis circuitry implements bit-by-bit comparison logic that identifies discrepancies between expected and observed patterns. These discrepancies indicate manufacturing defects that pattern recognition algorithms categorize according to their electrical characteristics and physical manifestations. The categorization includes stuck-at faults, coupling faults, and address decoder failures. The detection process generates pass/fail status indicators for each memory location, creating a comprehensive mapping of manufacturing defects throughout the respective memories of one or more processor cores. Test results are transferred to the TAP controller, which communicates with external test equipment through the JTAG Test/Debug interface, providing visibility into memory test outcomes.

### System-on-Chip

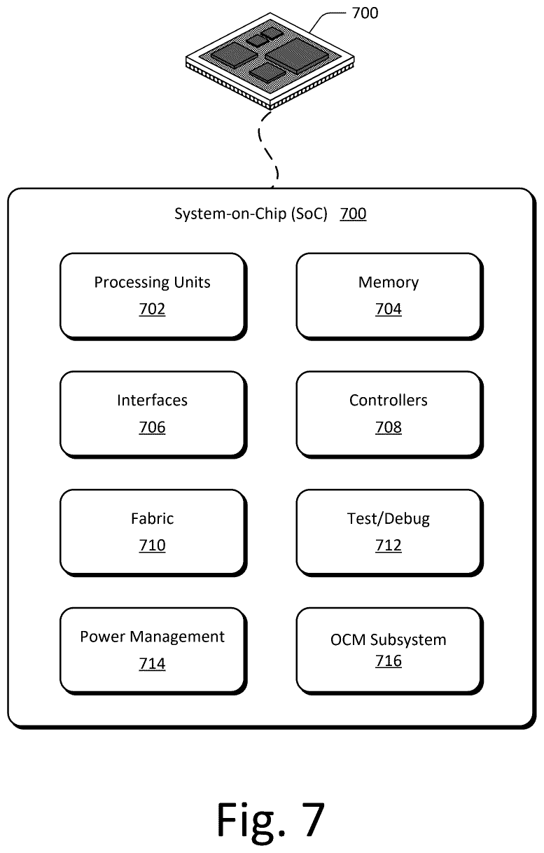

FIG. 7 illustrates an example System-on-Chip (SoC) 700 have an architecture that implements the technology described herein. The SoC 700 may be implemented in any suitable device, such as a smartphone, netbook, tablet computer, access point, network-attached storage, camera, smart appliance, printer, set-top box, server, solid-state drive (SSD), magnetic tape drive, hard-disk drive (HDD), storage drive array, memory module, storage media controller, storage media interface, head-disk assembly, magnetic media pre-amplifier, automotive computing system, or any other suitable type of device (e.g., others described herein). Although described with reference to a SoC, the entities of FIG. 7 may also be implemented as other types of integrated circuits or embedded systems, such as an Application-Specific Integrated-Circuit (ASIC), memory controller, storage controller, communication controller, application-specific standard product (ASSP), digital signal processor (DSP), programmable SoC (PSoC), system-in-package (SiP), or field-programmable gate array (FPGA).

The SoC 700 may be integrated with electronic circuitry, a microprocessor, memory, input-output (I/O) control logic, communication interfaces, firmware, and/or software useful to provide functionalities of a computing device or magnetic storage system, such as any of the devices or components described herein (e.g., hard-disk drive). The SoC 700 may also include an integrated data bus or interconnect fabric (not shown) that couples the various components of the SoC for data communication or routing between the components. The integrated data bus, interconnect fabric, or other components of the SoC 700 may be exposed or accessed through an external port, parallel data interface, serial data interface, peripheral component interface, or any other suitable data interface. For example, the components of the SoC 700 may access or control external storage media or magnetic write circuitry through an external interface or off-chip data interface.

In this example, the SoC 700 is depicted with various components, including processing units (PUs) 702, memory subsystems 704, interfaces 706, controllers 708, communication/interconnect fabric 710, test/debug infrastructure 712, power management (PM) subsystem 714, OCM subsystem 716 with a combined SMC-DMA unit, and/or other components not shown in FIG. 7.

Processing Units (PUs) 702 are the computational engines that execute instructions and perform calculations as part of the SoC 700. PUs 702 includes one or more CPUs/cores that execute the primary instruction sets and handle general-purpose computing tasks, which operate through defined instruction cycle sequences that process data according to programmed algorithms. In some instances, the PUs 702 includes Graphics Processing Units (GPUS) that specialize in parallel processing for rendering images, videos, and graphical user interfaces, which accelerate visual computations through architectures that exceed standard CPU capabilities by implementing thousands of processing cores simultaneously. In some instances, the PUs 702 includes Digital Signal Processors (DSPs) that focus on real-time signal processing tasks, which handle audio processing, communications protocols, and sensor data analysis through dedicated mathematical operation units. In some instances, the PUs 702 includes Hardware Accelerators (HWAs) that address specialized computational tasks, such as artificial intelligence (AI) inference, cryptographic operations, and media encoding/decoding. These HWAs offload specific workloads from general-purpose cores through application-specific integrated circuits. PUs 702 connects one or more memories of the memory subsystems 704 through the communication/interconnect fabric 710, which facilitates data retrieval and storage operations through standardized interface protocols.

PUs 702 executes instructions that constitute one or more applications, services, programs, routines, libraries, objects, components, data structures, or other logical constructs, which implement tasks, data types, state transformations of components, technical effects, or desired computational results through sequential instruction execution. In some instances, the PUs 702 includes one or more hardware or firmware logic machines configured to execute hardware or firmware instructions through dedicated execution pipelines that process binary operations. Processors of the PUs 702 operate as single-core or multi-core configurations, where the instructions executed thereon undergo sequential, parallel, or distributed processing through architectural designs that enable concurrent operation paths.

Memory subsystems 704 provide storage capabilities that maintain both data and instructions required by the PUs 702 through physical storage elements that retain information during operational cycles. In some instances, the memory subsystems 704 include OCM and external memory components that utilize different storage technologies, including random access memory (RAM), cache memory, static random-access memory (SRAM), and read-only memory (ROM), which operate through distinct access patterns and retention characteristics. Memory subsystems 704 includes memory controllers that regulate the flow of data between processing elements and physical memory locations, which manage address translation, timing synchronization, and interface protocol conversion through dedicated control circuits. Memory subsystems 704 connect to PUs 702 via direct interfaces or through the communication/interconnect fabric 710, which forms data transmission pathways that enable information exchange between computational and storage elements.

Memory subsystems 704 constitute computer-readable media that the PUs 702 utilize during operational execution, which function as the working or runtime memory that maintains active program states and data structures. Applications, data, and operating system components, embodied as computer-readable instructions, are stored in the memory subsystems 704. These components undergo execution by the PUs 702 through instruction fetch, decode, and execute cycles, which transform the stored information into computational operations.

Interfaces 706 establish connection points that facilitate communication between the SoC 700 and external components or between internal subsystems through standardized signal protocols and physical connections. In some instances, the interfaces 706 include external input/output (I/O) that comprises host interfaces and peripheral connections, which enable the SoC 700 to communicate with external memory, other chips, or peripheral devices through defined electrical and protocol specifications. In some instances, the interfaces 706 include internal interfaces that encompass AXI, DMA, and memory interfaces, which create standardized connection points between internal components that define signal timing, data formats, and control mechanisms through the implementation of protocol specifications. In some instances, the interfaces 706 connects to the communication/interconnect fabric 710 and directly to specific components, forming both system-wide and dedicated pathways for data exchange through selective routing and interface adaptation. Interfaces 706 implement protocol conversion functions, which enable components that use different communication methods to exchange data effectively through signal translation and timing adaptation circuits.

Controllers 708 serve as management units that coordinate operations between various components in the SoC 700 through control signal generation and data path coordination. In some instances, the controllers 708 include memory controllers that direct memory access operations, which execute address mapping, read/write sequencing, and timing synchronization for memory resources through dedicated control logic that interprets access requests and generates appropriate memory interface signals. In some instances, the controllers 708 include DMA controllers that supervise direct memory access operations, transferring data between memory locations without CPU intervention. This reduces processor overhead for memory-intensive operations through autonomous data movement circuits. In some instances, the controllers 708 include Input/Output (I/O) controllers that manage input/output operations between the SoC 700 and external devices, which perform protocol conversion, buffering, and flow control for peripherals through interface translation circuits. Controllers 708 connect to both the components they manage and to the communication/interconnect fabric 710, which enables them to receive commands from PUs 702 and coordinate data movement throughout the system through bidirectional control and data pathways.

Communication/interconnect fabric 710 operates as the transportation network that enables data movement between different components of the SoC 700 through physical interconnection pathways that carry digital signals. In some instances, the communication/interconnect fabric 710 includes an AXI interconnect that implements the AXI protocol, which serves as the primary system bus that establishes standardized communication pathways between components through defined signal timing and data transfer specifications. Communication/interconnect fabric 710 includes a Network-on-Chip (NoC) that applies packet-based routing techniques through switching nodes, which direct data packets between source and destination components according to routing algorithms. In some instances, the communication/interconnect fabric 710 includes specialized interconnects that offer optimized pathways for specific types of data movement, thereby enhancing performance for targeted operations, such as memory-to-memory transfers, through dedicated signal routing that bypasses general-purpose bus arbitration. In some instances, the communication/interconnect fabric 710 connects to virtually all other subsystems within the SoC 700, which forms the primary data exchange infrastructure through physical wire connections and protocol interfaces.

Test/debug infrastructure 712 provides mechanisms that verify functionality and diagnose problems within the SoC 700 through systematic testing procedures and diagnostic capabilities. In some instances, the test/debug infrastructure 712 includes MBIST controllers that conduct MBIST operations, which identify manufacturing defects in memory components by writing test patterns and reading back the results through automated test sequence generation and response comparison. In some instances, the test/debug infrastructure 712 includes TAP controllers that implement the JTAG interface protocol, which provides external access to internal test and debug features through standardized test signal interfaces that enable boundary scan operations. Test/debug infrastructure 712 includes debug infrastructure that consists of hardware components supporting software debugging and system validation. This infrastructure incorporates trace buffers, performance counters, and breakpoint mechanisms through dedicated monitoring circuits that capture operational data. Test/debug infrastructure 712 connects to multiple components throughout the SoC 700, which ensures comprehensive test coverage and observability through distributed test access points and centralized test control.

The Power Management (PM) subsystem 714 regulates energy consumption within the SoC 700 through multiple mechanisms that optimize efficiency by controlling power distribution and monitoring power consumption. In some instances, the PM subsystem 714 includes clock controls that govern the timing signals distributed throughout the chip, employing clock gating, frequency scaling, and domain-specific timing to reduce power consumption through selective signal activation and frequency adjustment. In some instances, the PM subsystem 714 includes power domains that segment the chip into regions with independent power control, which allow portions of the SoC 700 to power down when not in use through isolated power supply switching. In some instances, the PM subsystem 714 includes power controllers that implement logic to monitor system conditions and apply appropriate power states, utilizing voltage scaling, sleep modes, and wake-up mechanisms through automated power state management circuits. PM subsystem 714 interfaces with all other major components of the SoC 700, which establishes the control paths that adjust power states based on workload demands through distributed power control signals and centralized power management coordination.

The example SoC 700 also includes an OCM subsystem 716 with a combined SMC-DMA unit, DMA engine, and shared memory, such as the OCM subsystem 122 with the combined SMC-DMA unit 138, DMA engine 144, and shared memory 140 of FIG. 1, as described herein. The OCM subsystem 716 facilitates disaggregation of memory-to-memory operations through architectural configurations that enable the DMA engine to execute memory-to-memory operations by transferring data directly between memory banks and bypassing the AXI interconnect.

In aspects, the DMA engine of the OCM subsystem 716 executes memory-to-memory operations by transferring data directly between memory banks through an OCM-internal path. This path connects the SMC directly to the memory banks within the OCM subsystem. Consequently, intra-OCM operations bypass the AXI interconnect while maintaining connectivity to respective memories of processor cores via a DMA interconnect that operates independently from the AXI interconnect.

Any of these entities may be embodied as disparate or combined components, as described with reference to various aspects presented herein. Examples of these components and/or entities, or corresponding functionality, are described with reference to the respective components, entities, or respective configurations illustrated in FIGS. 1-6.

Although the subject matter of this disclosure has been described in language specific to structural features and/or methodological operations, it is to be understood that the subject matter defined in the appended claims is not necessarily limited to the specific examples, features, or operations described herein, including orders in which they are performed.

What is claimed is:

1. A system on a chip (SoC) that facilitates disaggregation of memory-to-memory operations, the SoC comprising:
a host interface configured to communicate with a host system;
one or more processor cores;
an Advanced extensible Interface (AXI) interconnect coupled between the host interface and the one or more processor cores; and
an on-chip memory (OCM) subsystem coupled to the AXI interconnect, the OCM subsystem comprising:
memory banks;
a DMA interconnect coupled directly with respective memories of the one or more processor cores; and
a shared memory controller coupled with the AXI interconnect, the memory banks, and the DMA interconnect, the shared memory controller comprising:
an OCM-internal path which connects the shared memory controller directly to the memory banks within the OCM subsystem; and
a direct memory access (DMA) engine configured to execute memory-to-memory operations by transferring data directly between the memory banks through the OCM-internal path or the respective memories of the one or more processor cores via the DMA interconnect.

2. The SoC of claim 1, wherein the DMA engine is further configured to execute memory-to-memory operations without employing the AXI interconnect.

3. The SoC of claim 1, wherein the DMA engine is further configured to execute memory-to-memory operations to transfer data to an external memory via the AXI interconnect.

4. The SoC of claim 1, wherein the DMA interconnect is coupled with a Memory Built-In Self-Test (MBIST) controller.

5. The SoC of claim 4, wherein the MBIST controller is configured to implement memory testing operations for the respective memories of the one or more processor cores via the DMA interconnect.

6. The SoC of claim 5, wherein the MBIST controller includes a shared-bus insertion test interface coupled with the DMA interconnect, the shared-bus insertion test interface including:
a shared bus block having input registers configured to latch test stimuli from the MBIST controller, output registers configured to capture read data, and a multiplexer configured to select read data from the respective memories of the one or more processor cores, the shared bus block configured to provide test communication between the MBIST controller and the respective memories of the one or more processor cores;
an MBIST input interface coupled to the shared bus block and the respective memories of the one or more processor cores by the DMA interconnect, the MBIST input interface configured to route the test stimuli to selected ones of the respective memories of the one or more processor cores; and
MBIST data-out paths from the respective memories of the one or more processor cores to the multiplexer, the MBIST data-out paths configured to return the read data from the respective memories of the one or more processor cores to the shared bus block for comparison by the MBIST controller.

7. The SoC of claim 5, wherein the MBIST controller is configured to:
generate memory test patterns;
transmit the test patterns to the respective memories of the one or more processor cores through dual-mode signal paths that are also used for functional data transfers;
receive memory test response data from the respective memories of the one or more processor cores through the dual-mode signal paths;
analyze the test response data to detect memory failures; and
maintain direct signal connections between functional logic and the respective memories of the one or more processor cores during transitions between normal operation mode and test mode.

8. The SoC of claim 1, wherein the DMA interconnect includes a daisy chain topology configured to provide access to the respective memories of the one or more processor cores, the daisy chain topology including:
a plurality of hops connected in series, including a first hop, each hop having a transmit interface and a receive interface configured to route data and coupled to a corresponding one of the respective memories of the one or more processor cores; and
a multiplexer having a transmit interface and a receive interface coupled to the first hop, wherein the transmit interface of each hop is coupled to the receive interface of a subsequent hop to enable data flow between the hops.

9. The SoC of claim 8, wherein selected ones of the plurality of hops include one or more light-weight DMA engines configured to receive DMA commands from the DMA engine and execute direct memory-to-memory transfers between the respective memories of the one or more processor cores coupled to different hops without routing data through the DMA engine.

10. The SoC of claim 8, wherein selected ones of the plurality of hops include one or more light-weight DMA engines configured to perform one or more of:
handle data transfers between memory subsystems;
perform computational operations on data locally;
include data manipulation units for encryption, error correction, data compression, or pattern recognition; and
implement arbitration logic for handling multiple data transfer requests.

11. The SoC of claim 1, wherein the DMA engine is configured to execute computational functions on data internal to the OCM subsystem, the computational functions include at least one of an Exclusive OR (XOR) operation, a Cyclic Redundancy Check (CRC) calculation, a hashing operation, or a pattern matching operation.

12. The SoC of claim 1, wherein the DMA engine is configured to perform memory scrubbing or memory initialization as DMA commands.

13. A method facilitating management of memory-to-memory operations in a System on Chip (SoC), which includes a host interface, one or more processor cores, an Advanced extensible Interface (AXI) interconnect coupled between the host interface and the one or more processor cores, and an on-chip memory (OCM) subsystem, the OCM subsystem comprising memory banks, and a shared memory controller with a direct memory access (DMA) engine, the method comprising:
receiving, at the shared memory controller, a request for a memory-to-memory operation;
determining that the memory-to-memory operation is between the memory banks of the OCM subsystem;
directing the memory-to-memory operation through an OCM-internal path that connects the shared memory controller directly to the memory banks, wherein the shared memory controller accesses the memory banks directly without traversing the AXI interconnect; and
executing the memory-to-memory operation by transferring data directly between the memory banks through the OCM-internal path.

14. The method of claim 13 further comprising:
determining that a second memory-to-memory operation is between the OCM subsystem and an external memory; and
directing the second memory-to-memory operation through the AXI interconnect.

15. The method of claim 13 further comprising:
determining that a third memory-to-memory operation is between the OCM subsystem and respective memories of the one or more processor cores of the SoC; and
directing the third memory-to-memory operation through a DMA interconnect, which is coupled directly with the respective memories of the one or more processor cores.

16. The method of claim 15 further comprising:
transferring data between the respective memories of the one or more processor cores using one or more light-weight DMA engines of the DMA interconnect; and
performing computational operations on data at the one or more light-weight DMA engines.

17. The method of claim 13 further comprising executing computational functions on data internal to the OCM subsystem, wherein the computational functions include at least one of an Exclusive OR (XOR) operation, a Cyclic Redundancy Check (CRC) calculation, a hashing operation, or a pattern matching operation.

18. A method facilitating performance of Memory Built-In Self-Test (MBIST) of a System on Chip (SoC), which includes one or more processor cores, respective memories of the one or more processor cores, MBIST circuitry, and dual-mode signal paths connecting functional logic to the respective memories of the one or more processor cores, the method comprising:
generating memory test patterns;
transmitting the test patterns to the respective memories of the one or more processor cores through the dual-mode signal paths that are also used for functional data transfers;
receiving memory test response data from the respective memories of the one or more processor cores through the dual-mode signal paths;
analyzing the test response data to detect memory failures; and
maintaining direct signal connections between the functional logic and the respective memories of the one or more processor cores during transitions between normal operation mode and test mode.

19. The method of claim 18 further comprising:
routing the test patterns through separate write paths to the respective memories of the one or more processor cores; and
routing the test response data through separated read paths from the respective memories of the one or more processor cores.

20. The method of claim 18, further comprising:
accessing the respective memories of the one or more processor cores through a shared path that enables the respective memories to be accessed as a single virtual memory; and
coordinating, by the MBIST circuitry, distribution of the memory test patterns and collection of the memory test response data across the respective memories of the one or more processor cores through the shared path.
